(19) United States
(12) Patent Application Publication
(10) Pub. No.: US 2025/0309244 A1
(43) Pub. Date: Oct. 2, 2025

(54) CONVERSION-TYPE POSITIVE ELECTRODE WITH AN INORGANIC TOP LAYER

(71) Applicant: International Business Machines Corporation, Armonk, NY (US)

(72) Inventors: Murtaza Zohair, San Jose, CA (US); Maxwell Giammona, Fremont, CA (US); Linda Karin Sundberg, Los Gatos, CA (US); Charles Thomas Rettner, San Jose, CA (US); Khanh Nguyen, Morgan Hill, CA (US); Young-Hye Na, San Jose, CA (US)

(21) Appl. No.: 18/619,521

(22) Filed: Mar. 28, 2024

(51) Int. Cl. H01M 4/36; H01M 4/02; H01M 4/04; H01M 4/139; H01M 4/62

(52) U.S. Cl. CPC H01M 4/366; H01M 4/0402; H01M 4/0428; H01M 4/139; H01M 4/628; H01M 2004/028

(57) ABSTRACT

A conversion-type positive electrode and formation thereof. The conversion-type positive electrode includes a composite film and a porous inorganic layer formed on the top surface of the composite film, where the composite film includes an electrically conductive porous material and a conversion-type positive electrode active material, and where the porous inorganic layer does not undergo a reversible redox reaction during cycling of the conversion-type positive electrode.

### BACKGROUND

The present invention relates generally to the field of secondary energy storage devices, and more particularly, to secondary energy storage devices having a conversion-type positive electrode.

Secondary energy storage devices, or simply rechargeable batteries, are energy storage devices that can be electrically recharged after use to their original pre-discharge condition by passing current through the circuit in the opposite direction of the current during discharge. Rechargeable batteries are in high demand for a wide range of applications, from small batteries for industrial and medical devices, to larger batteries for electric vehicles (EVs) and grid energy storage systems. Each application requires a specific set of electrochemical performance characteristics, and in many critical and growing application species today, such as EVs, the batteries performance is still considered a major limiting factor for satisfying the high standard of performance to meet customers' needs.

Currently, the two types of rechargeable batteries that are typically discussed in both industry and academia are batteries that run via electrochemical intercalation/de-intercalation of acting ions, and batteries that run via conversion reactions of active electrode/electrolyte materials. The most widely used rechargeable batteries (aside from the lead-acid batteries used in internal combustion vehicles) are lithium-ion batteries (LIBs). Generally, most commercial LIBs today use a metal oxide or metal phosphate-based lithium intercalation material as the positive electrode, and a carbon-graphite-based intercalation material as the negative electrode. As the battery is charged or discharged, lithium ions are moved back and forth between the positive and negative electrodes through a liquid electrolyte as current.

Despite the rapid growth and success of LIBs, there remain several shortcomings to be overcome to meet the rapidly increasing market demand for higher performance batteries. One attractive alternative to conventional LIB positive electrode chemistries are conversion-based positive electrodes which have higher theoretical energy densities and specific energies compared to commonly used lithium-ion positive electrodes.

### SUMMARY

According to one embodiment of the present invention, a conversion-type positive electrode is disclosed. The conversion-type positive electrode includes a composite film and a porous inorganic layer formed on a top surface of the composite film, where the composite film includes an electrically conductive porous material and a conversion-type positive electrode active material, and where the porous inorganic layer does not undergo a reversible redox reaction during cycling of the conversion-type positive electrode.

According to another embodiment of the present invention, a secondary energy storage device is disclosed. The secondary energy storage device includes a negative electrode, a positive electrode, and a liquid electrolyte including at least one solvent and at least one salt. The positive electrode includes a composite film and a porous inorganic layer formed on a top surface of the composite film, where the composite film includes an electrically conductive porous material and a conversion-type positive electrode active material, and where the porous inorganic layer does not undergo a reversible redox reaction during cycling of the conversion-type positive electrode.

According to another embodiment of the present invention, a method of forming a conversion-type positive electrode is disclosed. The method includes preparing a slurry including an electrically conductive porous material, a polymeric binder, and a solvent. The method further includes drying the slurry to form a composite film. The method further includes depositing a porous inorganic material onto a top surface of the composite film to form a porous inorganic layer that coats the top surface of the composite film, where the porous inorganic layer does not undergo a reversible redox reaction during cycling of the conversion-type positive electrode.

### BRIEF DESCRIPTION OF THE SEVERAL VIEWS OF THE DRAWINGS

The drawings included in the present disclosure are incorporated into, and form part of, the specification. They illustrate embodiments of the present invention and, along with the description, serve to explain the principles of the present invention. The drawings are only illustrative of certain embodiments and do not limit the present invention.

FIG. 1 is a cross-sectional view of a composite film formed on top of a positive current collector, generally designated 100, in accordance with at least one embodiment of the present invention.

FIG. 2 is a cross-sectional view of the composite film formed on top of the positive current collector of FIG. 1 after depositing a porous inorganic layer on the top surface of the composite film, generally designated 200, in accordance with at least one embodiment of the present invention.

FIG. 3 is a cross-sectional view of an example conversion-type secondary energy storage device, generally designated 300, in accordance with at least one embodiment of the present invention.

FIG. 4 is a plot, generally designated 400, of the galvanostatic charge-discharge of a lithium-iodide (LiI) battery formed, in part from, carbon composite film including conductive carbon particles, a conversion-type positive electrode active material (LiI), and a polymeric binder.

FIG. 5 is a plot, generally designated 500, of the galvanostatic charge-discharge of a lithium-iodide (LiI) battery formed, in part from, a carbon composite film with an SiO₂ layer vapor-deposited onto the top surface of the carbon composite film, where the carbon composite film includes conductive carbon particles, a conversion-type positive electrode active material (LiI), and a polymeric binder.

FIG. 6 is a plot, generally designated 600, of the galvanostatic charge-discharge of a lithium-iodide (LiI) battery formed, in part from, a carbon composite film with an organosilicate precursor solution deposited onto the top surface of the carbon composite film, where the carbon composite film includes conductive carbon particles, a conversion-type positive electrode active material (LiI), and a polymeric binder.

FIG. 7 is a plot, generally designated 700, of the galvanostatic charge-discharge of a lithium-iodide (LiI) battery formed, in part from, a carbon composite film with an Al₂O₃ layer vapor-deposited onto the top surface of the carbon composite film, where the carbon composite film includes conductive carbon particles, a conversion-type positive electrode active material (LiI), and a polymeric binder.

FIG. 8 is a plot, generally designated 800, of the galvanostatic charge-discharge of a lithium-iodide (LiI) battery formed, in part from, a carbon composite film with an MnO₂ layer vapor-deposited onto the top surface of the carbon composite film, where the carbon composite film includes conductive carbon particles, a conversion-type positive electrode active material (LiI), and a polymeric binder.

FIG. 9 is a plot, generally designated 900, of the galvanostatic charge-discharge of a lithium-iodide (LiI) battery formed, in part from, a carbon composite film including conducive carbon particles, a conversion-type positive electrode active material (LiI), and a polymeric binder, where the conductive carbon particles are coated with a layer of SiO₂ at the single-particle level.

FIG. 10 is a plot, generally designated 1000, of the galvanostatic charge-discharge of a lithium-iodide (LiI) battery formed, in part from, a carbon composite film with an SiO₂ layer vapor-deposited onto the top surface of the carbon composite film, and a conversion-type positive electrode active material (LiI) deposited on top of the SiO₂ layer, where the carbon composite film includes conductive carbon particles and a polymeric binder.

### DETAILED DESCRIPTION

The present invention relates generally to the field of secondary energy storage devices, and more particularly, to secondary energy storage devices having a conversion-type positive electrode.

An attractive alternative to conventional lithium-ion battery (LIB) positive electrode chemistries is conversion-type positive electrodes, which have higher theoretical energy densities and specific energies compared to commonly used lithium-ion positive electrodes. However, during battery cycling, some the of conversion-type positive electrode active material may become soluble in the liquid electrolyte. Embodiments of the present invention recognize that dissolution of the conversion-type positive electrode active material in the electrolyte is the primary challenge for conversion-type positive electrodes. The dissolution of the soluble conversion-type positive electrode active material in the electrolyte leads to the loss of active material from the positive electrode, and the shuttling of soluble species through the electrolyte, which ultimately results in performance degradation and cell failure.

One possible solution to address these issues has been the single-particle level encapsulation of the conversion-type positive electrode active material within conductive carbons, metal oxides, and combinations thereof. However, embodiments of the present invention recognize that encapsulating individual positive electrode particles saturated with a conversion-type positive electrode active material limits the potential to achieve even more efficient batteries with higher specific capacities.

Embodiments of the present invention provide for a method of forming a conversion-type positive electrode, and the conversion-type positive electrode resulting therefrom, that restricts the migration of the conversion-type positive electrode active material out of the positive electrode, thereby maintaining more of the conversion-type positive electrode active material in the electrolyte to undergo conversion reactions. This is achieved by coating the top surface of the conversion-type positive electrode with a porous inorganic material. The conversion-type positive electrode of the present invention is formed from a composite film including an electrically conductive porous material, a conversion-type positive electrode active material, and optionally, one or more inactive components, such as a polymeric binder. A porous inorganic material is deposited onto the top surface of the composite film, which results in the formation of porous inorganic layer thereon. The resulting conversion type-positive electrode, including the porous inorganic layer formed on the top surface of the composite film, can be subsequently used in the assembly of a secondary energy storage.

It should be appreciated that the porous inorganic layer formed on the top surface of the composite film in accordance with embodiments of the present invention promotes adsorption of soluble conversion-type positive electrode active material. This is particularly advantageous in that a greater concentration of the conversion-type positive electrode active material is maintained within the positive electrode to undergo conversion reactions, which in turn results in cells with a higher specific capacity as compared to conventional conversion-type cells. It should further be appreciated that the porous inorganic layer formed on the top surface of the composite film in accordance with embodiments of the present invention acts as an electrically insulating barrier that inhibits the migration of the conversion-type positive electrode active material out of the positive electrode through the electrolyte. This is particularly advantageous in that the potential for cross-over of the soluble conversion-type positive electrode active material from the positive electrode to the negative electrode is significantly reduced, which in turn results in improved cell efficiency and cycle life.

According to one embodiment of the present invention, a conversion-type positive electrode is disclosed. The conversion-type positive electrode includes a composite film and a porous inorganic layer formed on a top surface of the composite film, where the composite film includes an electrically conductive porous material and a conversion-type positive electrode active material, and where the porous inorganic layer does not undergo a reversible redox reaction during cycling of the conversion-type positive electrode.

In an embodiment, the composite film further includes a polymeric binder.

In an embodiment, the porous inorganic layer formed on the top surface of the composite film includes a compound containing at least one metal or metalloid, and at least one non-metal, where a difference in electronegativity between the at least one non-metal and the at least one metal or metalloid is less than or equal to 1.8. In an embodiment, the at least one metalloid is selected from the group consisting of silicon, germanium, arsenic, antimony, boron, selenium, tellurium, and combinations thereof. In an embodiment, the at least one non-metal is selected from the group consisting of oxygen, nitrogen, phosphorus, carbon, sulfur, selenium, a halogen, and combinations thereof.

In an embodiment, the porous inorganic layer formed on the top surface of the composite film includes at least one compound selected from the group consisting of polysilanes, polycarbosilanes, a polysiloxanes, polysilazanes, and combinations thereof.

In an embodiment, the porous inorganic layer formed on the top surface of the composite film is formed from at least one compound selected from the group consisting of silicon dioxide (SiO₂), an organosilicate precursor solution of hydrogen silsesquioxane (HSQ) in methyl isobutyl ketone (MIBK), and combinations thereof.

In an embodiment, the porous inorganic layer formed on the top surface of the composite film includes at least one metal oxide selected from the group consisting of vanadium oxides, niobium oxides, tantalum oxides, chromium oxides, molybdenum oxides, tungsten oxides, and combinations thereof.

In an embodiment, a thickness of the porous inorganic layer formed on the top surface of the composite layer is less than or equal to 25 micrometers.

According to another embodiment of the present invention, a secondary energy storage device is disclosed. The secondary energy storage device includes a negative electrode, a positive electrode, and a liquid electrolyte including at least one solvent and at least one salt. The positive electrode includes a composite film and a porous inorganic layer formed on a top surface of the composite film, where the composite film includes an electrically conductive porous material and a conversion-type positive electrode active material, and where the porous inorganic layer does not undergo a reversible redox reaction during cycling of the conversion-type positive electrode.

In an embodiment, the secondary energy storage device further includes a positive current collector in direct contact with the bottom surface of the composite film, a negative current collector in direct contact with the negative electrode, and a separator located between the positive electrode and the negative electrode.

In an embodiment, the porous inorganic layer formed on the top surface of the composite film includes a compound containing at least one metal or metalloid, and at least one non-metal, where a difference in electronegativity between the at least one non-metal and the at least one metal or metalloid is less than or equal to 1.8.

In an embodiment, the at least one metalloid is selected from the group consisting of silicon, germanium, arsenic, antimony, boron, selenium, tellurium, and combinations thereof.

In an embodiment, the at least one non-metal is selected from the group consisting of oxygen, nitrogen, phosphorus, carbon, sulfur, selenium, a halogen, and combinations thereof.

In an embodiment, the porous inorganic layer formed on the top surface of the composite film includes at least one compound selected from the group consisting of polysilanes, polycarbosilanes, a polysiloxanes, polysilazanes, and combinations thereof.

In an embodiment, the porous inorganic layer formed on the top surface of the composite film is formed from at least one compound selected from the group consisting of silicon dioxide (SiO₂), an organosilicate precursor solution of hydrogen silsesquioxane (HSQ) in methyl isobutyl ketone (MIBK), and combinations thereof.

In an embodiment, the porous inorganic layer formed on the top surface of the composite film includes at least one metal oxide selected from the group consisting of vanadium oxides, niobium oxides, tantalum oxides, chromium oxides, molybdenum oxides, tungsten oxides, and combinations thereof.

In an embodiment, a thickness of the porous inorganic layer formed on the top surface of the composite layer is less than or equal to 25 micrometers.

According to another embodiment of the present invention, a method of forming a conversion-type positive electrode is disclosed. The method includes preparing a slurry including an electrically conductive porous material, a polymeric binder, and a solvent. The method further includes drying the slurry to form a composite film. The method further includes depositing a porous inorganic material onto the top surface of the composite film to form a porous inorganic layer that coats the top surface of the composite film, where the porous inorganic layer does not undergo a reversible redox reaction during cycling of the conversion-type positive electrode.

In an embodiment, the slurry further includes a conversion-type positive electrode active material.

In an embodiment, the method further includes adding a conversion-type positive electrode active material to the composite film prior to depositing the porous inorganic material onto the top surface of the composite film.

In an embodiment, depositing the porous inorganic material onto the top surface of the composite film includes conformally depositing one or more thin film coatings of silicon dioxide (SiO₂) using chemical vapor deposition.

In an embodiment, the porous inorganic material is a compound containing at least one metal or metalloid, and at least one non-metal, where a difference in electronegativity between the at least one non-metal and the at least one metal or metalloid is less than or equal to 1.8.

In an embodiment, depositing the porous inorganic material onto the top surface of the composite film includes conformally depositing one or more thin film coatings of silicon dioxide (SiO₂) using chemical vapor deposition.

In an embodiment, depositing the porous inorganic material onto the top surface of the composite film includes: preparing an organosilicate precursor solution of hydrogen silsesquioxane (HSQ) in methyl isobutyl ketone (MIBK), depositing the solution onto the top surface of the composite film, and thermally curing the solution to form a silicon dioxide (SiO₂) layer on the top surface of the composite film.

In an embodiment, a thickness of the porous inorganic layer formed on the top surface of the composite layer is less than or equal to 25 micrometers.

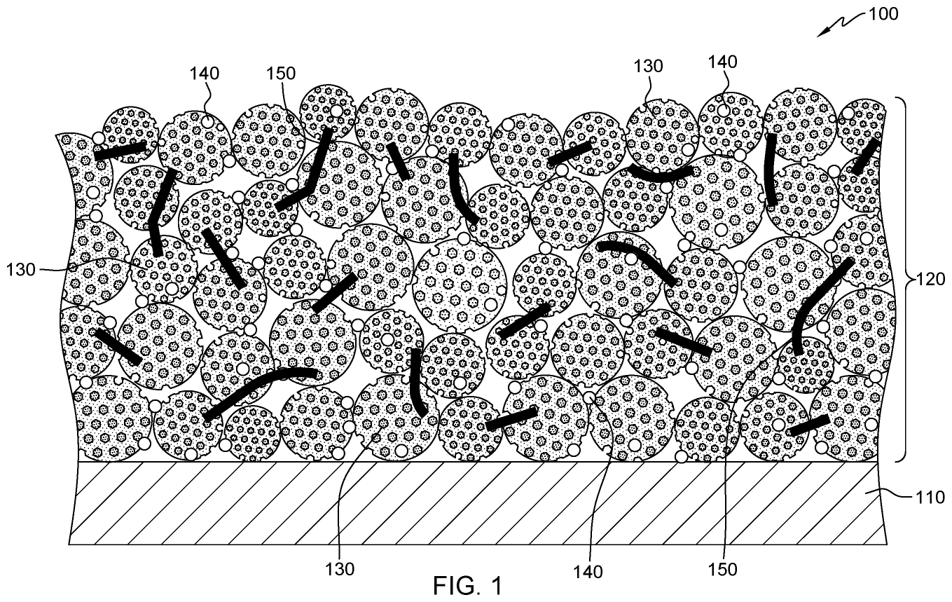

The present invention will now be described in detail with reference to the Figures, wherein like reference numerals refer to like elements throughout. FIG. 1 is a cross-sectional view of a composite film formed on top of a positive current collector, generally designated 100, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

As depicted by FIG. 1, a composite film 120, which functions as a conversion-type positive electrode, is formed on top of, and in direct contact with a positive current collector 110. The composite film 120 includes electrically conductive porous particles 130, and a conversion-type positive electrode active material 140. In some embodiments, the composite film 120 can act as a free-standing conversion-type positive electrode (i.e., the composite film 120 is not formed on top of the positive current collector 110). This may be the case when the electrical conductivity of the electrically conductive porous particles 130 alone is sufficient to collect and distribute electrons to/from an external circuit, such that the positive current collector 110 is not required.

The electrically conductive porous particles 130 of the composite film 120 form a percolating network of continuous mechanical connections and electrical pathways extending through the entire thickness of the composite film 120 to the current collector 110. The thickness of the composite film 120 may vary depending on the design and performance requirements of the battery. In an embodiment, the thickness of the composite film 120 is roughly 200 micrometers. The electrically conductive porous particles 130 may be formed from any material having a porosity and electrical conductivity that are suitable for the given application. In some embodiments, the electrically conductive porous particles 130 include carbon. In an embodiment, the electrically conductive porous particles 130 include at least one material selected from the group consisting of active carbon particles, carbon black particles, and combinations thereof.

The electrically conductive porous particles 130 further act as a host for the conversion-type positive electrode active material 140. As depicted by FIG. 1, the conversion-type positive electrode active material 140 is at least in direct contact with the electrically conductive porous particles 130. In some embodiments, depending on the porosity of the electrically conductive porous particles 130, the conversion-type positive electrode active material 140 may be embedded within and/or permeate the electrically conductive porous particles 130.

The conversion-type positive electrode active material 140 may be formed from any conversion-type positive electrode active materials having electrochemical properties that are suitable for the given application. In some embodiments, the conversion-type positive electrode active material 140 is a metal halide (e.g., MX, where M is a metal element and X is a halogen element) that dissociates into respective metal and halide ions. In an embodiment, the metal may include, but is not limited to, at least one of Li, Al, Mg, or Na (e.g., M may be Li, Al, Mg, or Na), and the halide may include, but is not limited to, at least one of I, Br, Cl, or F (e.g., X may be I, Br, Cl, or F). In an embodiment, the conversion-type positive electrode active material 140 is at least one compound selected from the group consisting of sulfur-based compounds, selenium-based compounds, and combinations thereof. In an embodiment, the conversion-type positive electrode active material 140 includes at least one compound selected from the group consisting of lithium iodide (LiI), sodium iodide (NaI), zinc iodide (ZnI₂), magnesium iodide (MgI₂), sodium bromide (NaBr), zinc bromide (ZnBr₂), and combinations thereof.

In some embodiments, and as depicted by FIG. 1, the composite film 120 may include one or more additional inactive components, such as a polymeric binder 150. The polymeric binder 150 increases the structural integrity of the composite film 120 by promoting cohesion between the electrically conductive porous particles 130, and adhesion of the composite film 120 itself to the positive current collector 110. Examples of suitable materials that may be employed as the polymeric binder 150 include, but are not limited to, cyclo-olefin polymers, poly-para-xylylenes, benzocyclobutenes, olefin addition polymers, olefin addition copolymers, ring opening metathesis polymers and reduced forms thereof, fluorocarbon addition polymers, fluoroether polymers, cyclobutyl fluoroethers, polyarylenes, polyarylene ethers, polybenzoazoles, polysiloxanes, silsequioxanes, polycarvosilanes, or combinations thereof.

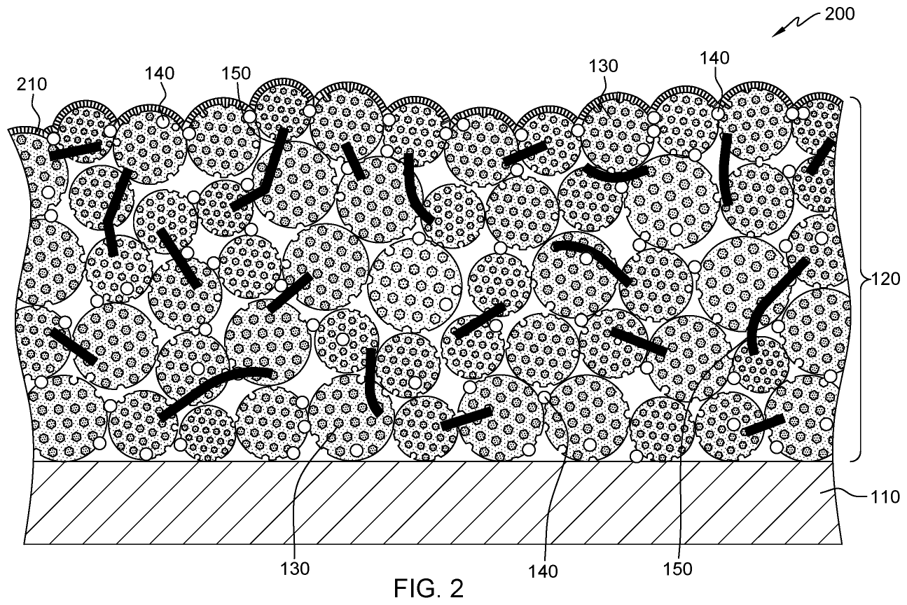

FIG. 2 is a cross-sectional view of the composite film formed on top of the positive current collector of FIG. 1 after forming a porous inorganic layer on the top surface of the composite film, generally designated 200, in accordance with at least one embodiment of the present invention. FIG. 2 provides an illustration of only one implementation and does not imply any limitations with regard to the environments in which different embodiments may be implemented. Many modifications to the depicted environment may be made by those skilled in the art without departing from the scope of the present invention as recited by the claims.

As depicted by FIG. 2, a porous inorganic layer 210 has been formed on the top surface of the composite film 120. The combination of the composite film 120 and the porous inorganic layer 210 results in the formation of a conversion-type positive electrode that restricts the migration of the conversion-type positive electrode active material 140 out of the composite film 120. However, it should be appreciated that only the composite film 120, and not the porous inorganic layer 210, underdoes a reversible redox reaction during cycling of the conversion-type positive electrode.

The porous inorganic layer 210 may be formed by conformally depositing one or more thin film coatings of a porous inorganic material onto the top surface of the composite film 120 using known techniques including, but not limited to, chemical vapor deposition (CVD), plasma enhanced chemical vapor deposition (PECVD), atomic layer deposition (ALD), physical vapor deposition (PVD), sputtering, chemical solution deposition, solution casting, or combinations thereof. The thickness of the porous inorganic layer 210 may vary depending on the deposition process used, the number of layers of material deposited, as well as the material employed. In an embodiment, the thickness of the porous inorganic layer 210 is less than or equal to 25 micrometers. It should be appreciated that the porous inorganic layer 210 may be relatively thin as compared to the thickness of the composite film 120, while still effectively restricting the migration of the soluble conversion-type positive electrode active material 140 out of the composite film 120. This is particularly advantageous in that the dimensions of the conversion-type positive electrode may remain substantially unaffected by the introduction of the porous inorganic layer 210 onto the top surface of the composite film 120.

It should further be appreciated that only the top surface of the composite film 120, and not the electrically conductive porous particles 130 themselves, is coated with the porous inorganic layer 210. In other words, the porous inorganic layer 210 does not encapsulate the electrically conductive porous particles 130 at the single-particle level. In some embodiments, the porous inorganic layer 210 does not penetrate the top surface of the composite film 120, but rather remains on the outer, top surface of the composite film 120. This may be the case when the pore size of the electrically conductive porous particles 130 and any additional inactive components, such as the polymeric binder 150, have a pore size below a threshold value (e.g., below a threshold diameter). In some embodiments, the porous inorganic layer 210 may penetrate the top surface of the composite film 120, such that a portion of the porous inorganic layer 210 permeates an uppermost portion of composite film 120. This may be the case when the pore size of the electrically conductive porous particles 130 and any additional inactive components, such as the polymeric binder 150, have a pore size above a threshold value (e.g., above a threshold diameter). However, it should be noted that in those instances where the porous inorganic layer 210 penetrates the top surface of the composite film 120, the porous inorganic layer 210 does not permeate through the entire thickness of the composite film 120.

The porous inorganic layer 210 includes a compound containing at least one metal or metalloid, and at least one non-metal. For example, the porous inorganic layer 210 may include a compound that contains at least one metal (e.g., tantalum) and at least one non-metal (e.g., oxygen), which when combined, form the compound tantalum pentoxide (Ta₂O₅). In another example, the porous inorganic layer 210 may include a compound that contains at least one metalloid (e.g., silicon) and at least one non-metal (e.g., oxygen), which when combined, form the compound silicon dioxide (SiO₂).

In some embodiments, the difference in electronegativity between the at least one non-metal and the at least one metal or metalloid of the compound is less than or equal to 1.8. Electronegativity is the tendency for an atom of a given chemical element to attract shared electrons when forming a chemical bond. An atom's electronegativity is affected by both its atomic number and the size of the atom. The higher its electronegativity, the more a chemical element attracts electrons. Electronegativity is not directly measured, but is instead calculated based on experimental measurements of other atomic or molecular properties. Several methods of calculation have been proposed, and although there may be small differences in the numerical values of the calculated electronegativity values, all methods show the same periodic trend among the elements. The most commonly used method of calculation for electronegativity is Pauling's method. This method yields a dimensionless quantity, commonly referred to as the Pauling scale, with a range from 0.7 to 4.

The following examples are based on the Pauling scale. In one example, if a compound contains a metal (e.g., chromium) and a non-metal (e.g., nitrogen), and the respective electronegativities of chromium and nitrogen are 1.66 and 3.04, then it can be said that the difference in electronegativity between the non-metal (nitrogen) and the metal (chromium) is 1.38. Accordingly, the porous inorganic layer 210 may include the compound chromium nitride (CrN) since chromium nitride contains a metal (chromium) and a non-metal (nitrogen), and the difference in electronegativity between the non-metal (nitrogen) and the metal (chromium) is 1.38, which is less than 1.8. In another example, if a compound contains a metalloid (e.g., silicon) and a non-metal (e.g., oxygen), and the respective electronegativity of silicon and oxygen are 1.9 and 3.44, then it can be said that the difference in electronegativity between the non-metal (oxygen) and the metalloid (silicon) is 1.54. Accordingly, the porous inorganic layer 210 may include the compound silicon dioxide (SiO₂) since silicon dioxide contains a metalloid (silicon) and a non-metal (oxygen), and the difference in electronegativity between the non-metal (oxygen) and the metalloid (silicon) is 1.54, which is less than 1.8.

In another example, if a compound contains a metal (e.g., hafnium) and non-metal (e.g., oxygen), and the respective electronegativities of hafnium and oxygen are 1.3 and 3.44, then it can be said that the difference in electronegativity between the non-metal (oxygen) and the metal (hafnium) is 2.14. Accordingly, although the compound hafnium oxide (HfO₂) contains a metal (hafnium) and a non-metal (oxygen), since the difference in electronegativity between the non-metal (oxygen) and the metal (hafnium) is 2.14, which is greater than 1.8, the porous inorganic layer 210 may not include the compound hafnium oxide. In yet another example, if a compound contains a metalloid (e.g., silicon) and non-metal (e.g., fluorine), and the respective electronegativities of silicon and fluorine are 1.9 and 3.98, then it can be said that the difference in electronegativity between the non-metal (fluorine) and the metalloid (silicon) is 2.08. Accordingly, although the compound silicon tetrafluoride contains a metalloid (silicon) and a non-metal (fluorine), the porous inorganic layer 210 may not include the compound silicon tetrafluoride since the difference in electronegativity between the non-metal (fluorine) and the metalloid (silicon) is 2.08, which is greater than 1.8.

In some embodiments, a concentration gradient may exist with respect to one or more elements of the chemical compound used to form the porous inorganic layer 210. For example, in an embodiment in which the porous inorganic layer 210 includes silicon dioxide (SiO₂), a concentration gradient exists with respect to silicon (Si), in which the concentration of silicon is higher at the top of the porous inorganic layer 210 than at the bottom of the porous inorganic layer 210.

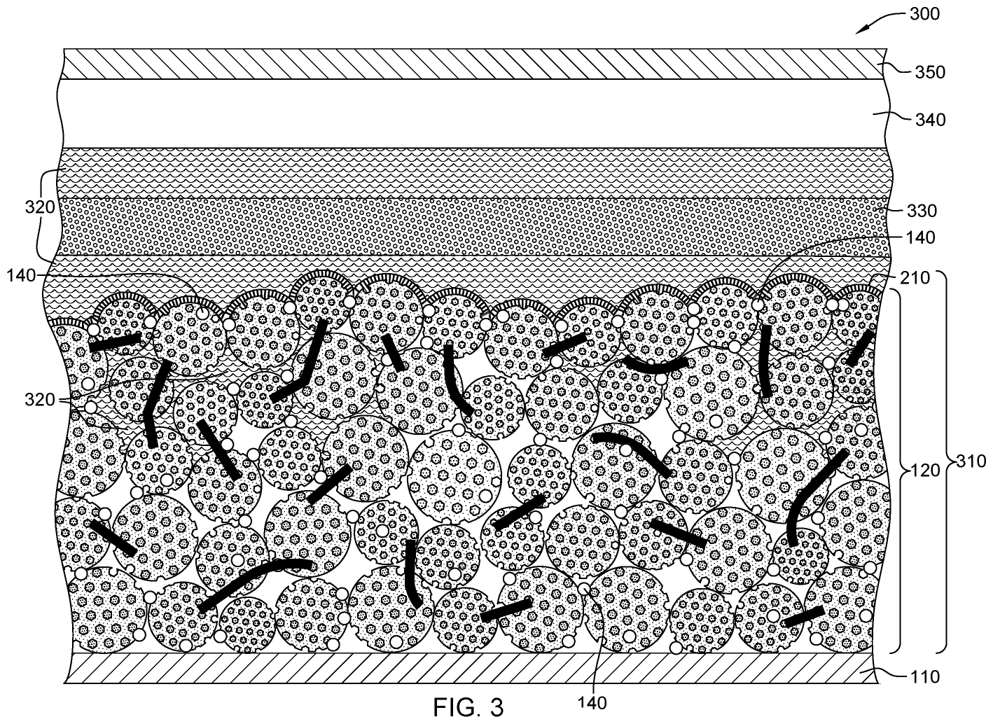

FIG. 3 is a schematic, cross-sectional view of an example conversion-type secondary energy storage device, generally designated 300, in accordance with at least one embodiment of the present invention. FIG. 3 provides an illustration of only one implementation and does not imply any limitations with regard to the environments in which different embodiments may be implemented. Many modifications to the depicted environment may be made by those skilled in the art without departing from the scope of the present invention as recited by the claims.

The conversion-type secondary energy storage device 300 (hereinafter referred to as battery 300) includes the positive current collector 110, a conversion-type positive electrode 310, a liquid electrolyte 320, a separator 330, a negative electrode 340, and a negative current collector 350. The battery 300 operates via reduction-oxidation (redox) reactions. For example, battery 300 utilizes different oxidation states and redox reactions of one or more components or elements to charge and discharge the battery 300.

The positive current collector 110 collects electrons generated by a redox reaction during discharge of the battery 300 and provides a conductive path to an external circuit to which the battery 300 is connected to. Similarly, the positive current collector 110 provides an electrical pathway from an external voltage source to supply voltage for another redox reaction to charge the battery 300. The positive current collector 110 may be formed from any materials of suitable electrical conductivity that achieve stability or passivation at the respective electrochemical potential of the conversion-type positive electrode 310. In an embodiment, the positive current collector 110 may be formed from a porous material that is electrically conductive. In an embodiment, the positive current collector 110 may be formed from woven or non-woven metal fibers, metal foam, or woven or non-woven carbon fibers. For example, the positive current collector 110 may include stainless-steel mesh, aluminum (Al) mesh, nickel (Ni) foam, carbon paper, or combinations thereof.

The conversion-type positive electrode 310 is formed on top of, and in direct contact with, the positive current collector 110. The conversion-type positive electrode 310 includes the composite film 120 and the porous inorganic layer 210 formed on the top surface of the composite film 120. As depicted by FIG. 3, the composite film 120 of the conversion-type positive electrode 310 further includes a liquid electrolyte 320. It should be appreciated that the porous inorganic layer 210 formed on the top surface of the composite film 120 permits the flow of metal ions between the conversion-type positive electrode 310 and the negative electrode 340 through the liquid electrolyte 320, but restricts the migration of the conversion-type positive electrode active material 140 out of the positive electrode 310 by absorbing the conversion-type positive electrode active material 140 when dissolved in the liquid electrolyte 320.

The liquid electrolyte 320 may be formed from at least one solvent and at least one salt having electrochemical properties that are suitable for the given application. Examples of suitable solvents include, but are not limited to, carbonate compounds, heterocyclic compounds, ethers, esters, cyclic ethers, cyclic esters, nitriles, or combinations thereof. In an embodiment, the at least one solvent of the liquid electrolyte 320 is selected from the group consisting of diethyl carbonate (DEC), dimethyl carbonate (DMC), ethylene carbonate (EC), propylene carbonate (PC), diglyme, dimethoxyethane (DME), dioxolane, and combinations thereof.

In some embodiments, the at least one salt of the liquid electrolyte 320 is a metal salt. In an embodiment, the at least one salt of the liquid electrolyte 320 is an alkali metal salt. In an embodiment, the at least one salt of the liquid electrolyte 320 is selected from the group consisting of lithium hexafluorophosphate (LiPF₆), lithium bis(trifluoromethanesulfonyl)imide (LiTFSI), lithium bis(fluoromethanesulfonyl)imide (LiFSI), lithium nitrate (LiNO₃), lithium bis(oxalate) borate (LiBOB), sodium hexafluorophosphate (NaPF₆), magnesium bis(trifluoromethanesulfonyl)imide (MgTFSI), and combinations thereof.

The separator 330 forces electrons through an external circuit to which the battery 300 is connected to by preventing the transmission of the electrons directly through the liquid electrolyte 320, while still enabling the metal ions to flow through battery 300 during charge and discharge. In various embodiments, the separator 330 may be coated with the liquid electrolyte 320, soaked with the liquid electrolyte 320, and/or submerged within the liquid electrolyte 320. In an embodiment, the separator 330 includes a non-conductive material to prevent movement of electrons through the battery 300, such that the electrons move through an external circuit instead. For example, the separator 330 may include glass, non-woven fibers, polymer films, or rubber.

The negative electrode 340 takes up metal ions from the electrolyte 320 during charging, and releases the metal ions to the electrolyte 320 during discharging. The negative electrode 340 may be formed from any materials having electrochemical properties that are suitable for the given application. In some embodiments, the negative electrode 340 may be formed from a metal including, but not limited to, lithium, magnesium, sodium, or combinations thereof. In an embodiment, the negative electrode 340 consists essentially of elemental lithium, elemental magnesium or elemental sodium, or lithium, magnesium or sodium alloyed with one or more additional elements. In some embodiments, the negative electrode 340 may be formed from intercalation materials including, but not limited to, graphite, carbon nanotubes, carbon nanofibers, silicon nanowires, silicon nanoparticles, or combinations thereof.

The negative current collector 350 collects electrons generated by a redox reaction during discharge of the battery 300 and provides a conductive path to an external circuit to which the battery 300 is connected to. Similarly, during recharge of the battery 300, the negative current collector 350 provides an electrical pathway between an external voltage source and the electrolyte 320 to supply voltage for another redox reaction to charge the battery 300. The negative current collector 350 may be formed from any materials of suitable electrical conductivity that achieve stability or passivation at the respective electrochemical potential of the negative electrode 340. In an embodiment, the negative current collector 350 may be formed from a porous material that is electrically conductive. In an embodiment, the negative current collector 350 may be formed from woven or non-woven metal fibers, metal foam, or woven or non-woven carbon fibers. For example, the negative current collector 350 may be formed from stainless-steel mesh, aluminum (Al) mesh, nickel (Ni) foam, or combinations thereof.

### PROCEDURE 1

### Preparation of a Carbon Composite Film Functioning as a Conversion-Type Positive Electrode

Procedure 1A. A conversion-type positive electrode was prepared by initially forming a slurry including a mixture of activated carbon particles (MSC-30SS, Kansai Coke and Chemicals Corporation) and high conductivity carbon particles (Ketjen Black, Lion Chemical Corporation), a polymeric binder (styrene-butadiene rubber), and a solvent. In an embodiment in which the solvent is high purity water, a surfactant (e.g., carboxy-methyl cellulose) may additionally be added to the slurry to prevent agglomeration of the carbon particles. In an embodiment in which the solvent is an organic solvent (e.g., N-methyl-2-pyrrolidone or dimethylacetamide), the addition of a surfactant is optional. The slurry was then mixed (e.g., using a rotary or tumble mixer), coated onto a current collector using, for example, tape-casting (i.e., doctor blading or knife coating), dried to produce a carbon composite film, and the carbon composite film punched to form a disk (e.g., 11 mm in diameter).
Procedure 1B. A conversion-type positive electrode active material (lithium iodide (LiI)) was added to the carbon composite film by first dissolving LiI in a solvent (menthanol) to form a solution, and then depositing the solution, using drop-casting, onto the top surface of the carbon composite film. The conversion-type positive electrode active material (LiI) was 60 wt % of the total mass of the carbon composite film.

### PROCEDURE 2

### Forming a Porous Inorganic Layer on Top of the Carbon Composite Film

Procedure 2A. A layer of silicon dioxide (SiO₂) was formed on top of the carbon composite film (formed by Procedures 1A and 1B) by depositing, using vapor deposition, a coating of silicon dioxide (SiO₂) onto the top surface of the carbon composite film.
Procedure 2B. A layer of silicon dioxide (SiO₂) was formed on top of the carbon composite film (formed by Procedures 1A and 1B) by preparing an organosilicate precursor solution of hydrogen silsesquioxane (HSQ) in methyl isobutyl ketone (MIBK), depositing, using drop casting, the solution onto the top surface of the carbon composite film, and thermally curing the solution to form the silicon dioxide (SiO₂) layer.
Procedure 2C. A layer of aluminum oxide (Al₂O₃) was formed on top of the carbon composite film (formed by Procedures 1A and 1B) by depositing, using vapor deposition, a coating of aluminum oxide (Al₂O₃) onto the top surface of the carbon composite film.
Procedure 2D. A layer of manganese oxide (MnO₂) was formed on top of the carbon composite film (formed by Procedures 1A and 1B) by depositing, using vapor deposition, a coating of aluminum oxide (Al₂O₃) onto the top surface of the carbon composite film.

### Example 1

Carbon Composite Film with Silicon Dioxide (SiO₂) Layer

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode formed in accordance with Procedure 1A, Procedure 1B, and Procedure 2A. Finally, the positive side of the CR2032 type cell coin case was placed on top of the conversion-type positive electrode, and the coin cell was sealed using a coin cell crimper.

### Example 2

Carbon Composite Film with Silicon Dioxide (SiO₂) Layer

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode formed in accordance with Procedure 1A, Procedure 1B, and Procedure 2B. Finally, the positive side of the CR2032 type cell coin case was placed on top of the conversion-type positive electrode, and the coin cell was sealed using a coin cell crimper.

### Comparative Example 1—Control

Carbon Composite Film without Silicon Dioxide (SiO₂) Layer

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode formed in accordance with Procedure 1A and Procedure 1B. Finally, the positive side of the CR2032 type cell coin case was placed on top of the conversion-type positive electrode, and the coin cell was sealed using a coin cell crimper.

### Comparative Example 2

Carbon Composite Film with Aluminum Oxide (Al₂O₃) Layer

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode formed in accordance with Procedure 1A, Procedure 1B, and Procedure 2C. Finally, the positive side of the CR2032 type cell coin case was placed on top of the conversion-type positive electrode, and the coin cell was sealed using a coin cell crimper.

### Comparative Example 3

Carbon Composite Film with Manganese Oxide (MnO₂) Layer

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode formed in accordance with Procedure 1A, Procedure 1B, and Procedure 2D. Finally, the positive side of the CR2032 type cell coin case was placed on top of the conversion-type positive electrode, and the coin cell was sealed using a coin cell crimper.

### Comparative Example 4

Carbon Composite Film with Carbon Particles Coated with Silicon Dioxide (SiO₂) at the Particle Level

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode. The conversion-type positive electrode was formed by in part, in accordance with Procedure 1A. However, prior to forming the slurry, the mixture of activated carbon particles and high conductivity carbon particles were coated with silicon dioxide (SiO₂) at the single-particle level.

### Comparative Example 5

Carbon Composite Film with Conversion-Type Positive Electrode Active Material Deposited on top of Silicon Dioxide (SiO₂) Layer

A lithium iodide (LiI) battery was formed by placing a wave spring within the negative side of a CR2032 type coin cell case. A piece of lithium foil cut into a 13 mm disk (serving as the negative electrode) was mounted onto a stainless-steel disc (serving as the negative electrode current collector) and placed on top of the wave spring. A polymer separator (e.g., Celgard 2325), soaked with a liquid electrolyte (e.g., 0.5 M LiTFSI, 0.4 M LiBOB, 0.2 M LiNO₃ in a 1:1 v/v mixture of 1,3-dioxolane and dimethoxyethane) was placed on top of the lithium foil, followed by a conversion-type positive electrode formed, in part, in accordance with Procedures 1A and 2A. However, rather than adding the conversion-type positive electrode active material (Lil) to the carbon composite film in accordance with Procedure 1B, the conversion-type positive electrode active material (LiI) was deposited on top of the silicon dioxide (SiO₂) layer. Finally, the positive side of the CR2032 type cell coin case was placed on top of the conversion-type positive electrode, and the coin cell was sealed using a coin cell crimper.

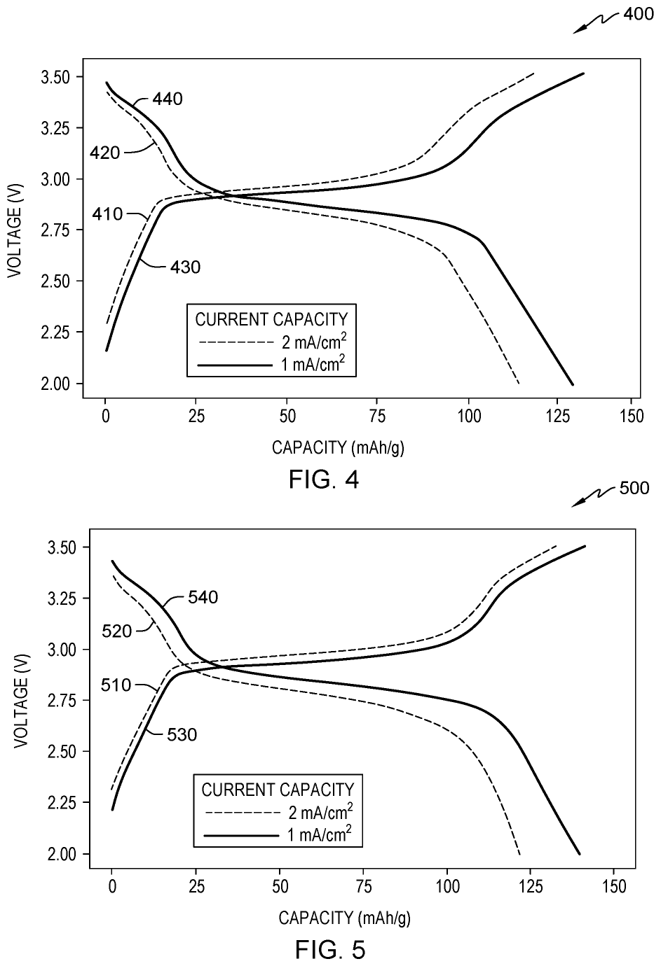

Returning to the Figures, FIG. 4 is a plot, generally designated 400, of the galvanostatic charge-discharge curves of the LiI battery formed in accordance with Comparative Example 1-Control. In particular, the LiI battery of Comparative Example 1-Control was formed, in part from, a carbon composite film including conductive carbon particles, a conversion-type positive electrode active material (lithium iodide), and a polymeric binder. The charge curve 410 and the discharge curve 420 were acquired at a current density of 2 mA/cm², while the charge curve 430 and the discharge curve 440 were acquired at a current density of 1 mA/cm².

FIG. 5 is a plot, generally designated 500, of the galvanostatic charge-discharge curves of the Lil battery formed in accordance with Example 1. In particular, the LiI battery of Example 1 was formed, in part from, a carbon composite film with an SiO₂ layer vapor-deposited onto the top surface of the carbon composite film, where the carbon composite film includes conductive carbon particles, a conversion-type positive electrode active material (LiI), and a polymeric binder. The charge curve 510 and the discharge curve 520 were acquired at a current density of 2 mA/cm², while the charge curve 530 and the discharge curve 540 were acquired at a current density of 1 mA/cm². The charge and discharge capacities of the secondary energy storage device formed in accordance with Example 1 outperform the charge and discharge capacities of the secondary energy storage device formed in accordance with Comparative Example 1-Control (see FIG. 4 for comparison).

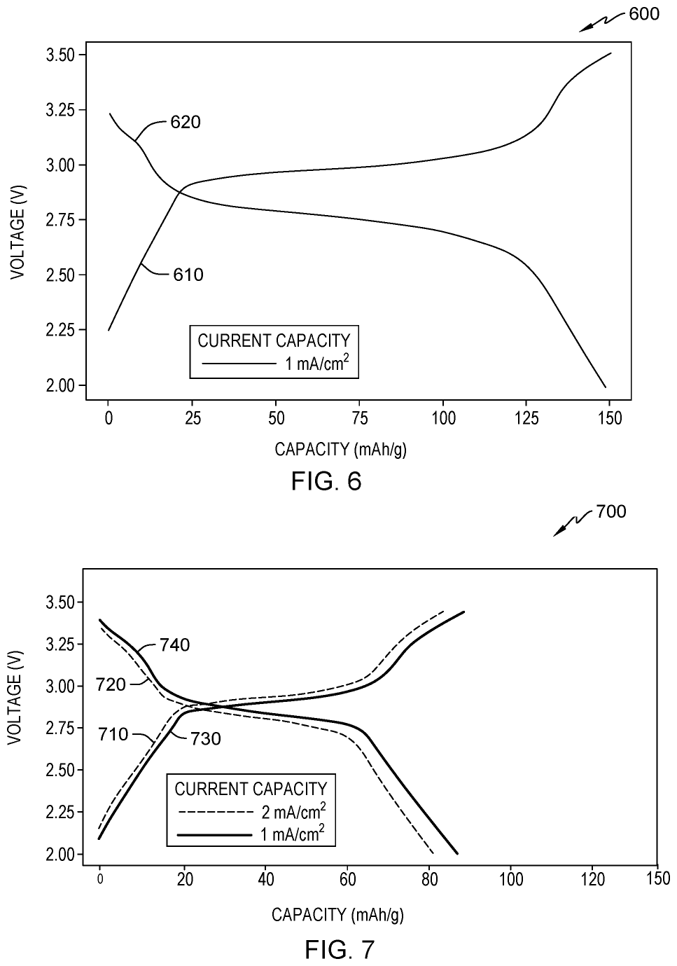

FIG. 6 is a plot, generally designated 600, of the galvanostatic charge-discharge curves of the LiI battery formed in accordance with Example 2. In particular, the LiI battery of Example 2 was formed, in part from, a carbon composite film with an organosilicate precursor solution deposited onto the top surface of the carbon composite film, where the carbon composite film includes conductive carbon particles, a conversion-type positive electrode active material (Lil), and a polymeric binder. The charge curve 610 and the discharge curve 620 were acquired at a current density of 1 mA/cm². The charge and discharge capacities of the secondary energy storage device formed in accordance with Example 2 outperform the charge and discharge capacities of the secondary energy storage device formed in accordance with Comparative Example 1-Control Cell (see FIG. 4 for comparison).

FIG. 7 is a plot, generally designated 700, of the galvanostatic charge-discharge curves of the Lil battery formed in accordance with Comparative Example 2. In particular, the LiI battery of Comparative Example 2 was formed, in part from, a carbon composite film with an Al₂O₃ layer vapor-deposited onto the top surface of the carbon composite film, where the carbon composite film includes conductive carbon particles, a conversion-type positive electrode active material (LiI), and a polymeric binder. The charge curve 710 and the discharge curve 720 were acquired at a current density of 2 mA/cm², while the charge curve 730 and the discharge curve 740 were acquired at a current density of 1 mA/cm². The charge and discharge capacities of the secondary energy storage device formed in accordance with Comparative Example 2 are lower than the charge and discharge capacities of the secondary energy storage device formed in accordance with Comparative Example 1-Control (see FIG. 4 for comparison).

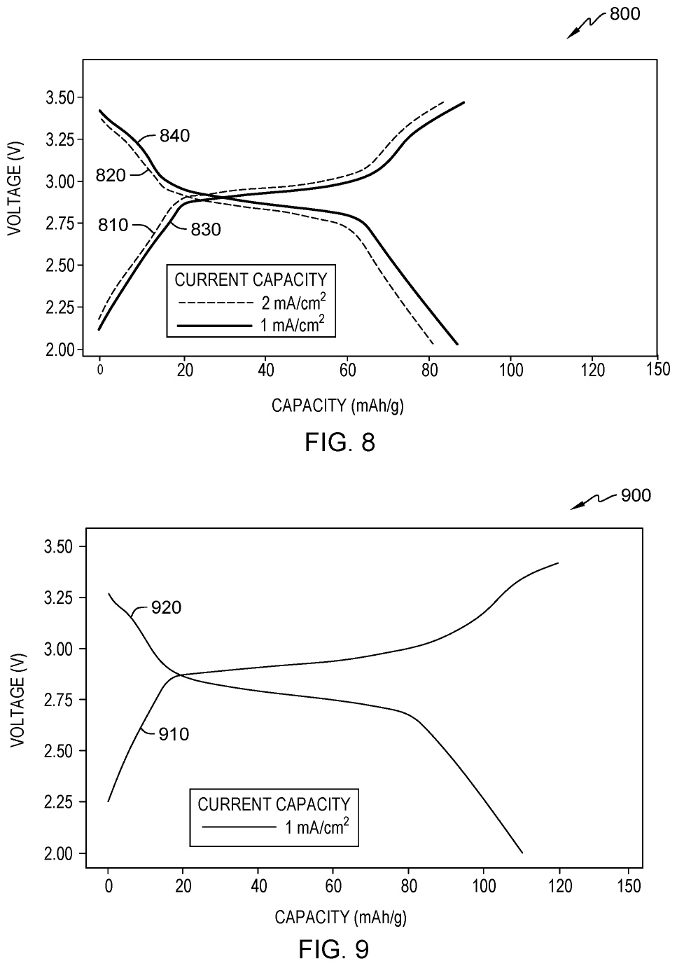

FIG. 8 is a plot, generally designated 800, of the galvanostatic charge-discharge curves of the LiI battery formed in accordance with Comparative Example 3. In particular, the LiI battery of Comparative Example 3 was formed, in part from, a carbon composite film with an MnO₂ layer vapor-deposited onto the top surface of the carbon composite film, where the carbon composite film includes conductive carbon particles, a conversion-type positive electrode active material (LiI), and a polymeric binder. The charge curve 810 and the discharge curve 820 were acquired at a current density of 2 mA/cm², while the charge curve 830 and the discharge curve 840 were acquired at a current density of 1 mA/cm². The charge and discharge capacities of the secondary energy storage device formed in accordance with Comparative Example 3 are lower than the charge and discharge capacities of the secondary energy storage device formed in accordance with Comparative Example 1-Control (see FIG. 4 for comparison).

FIG. 9 is a plot, generally designated 900 of the galvanostatic charge-discharge curves of the LiI battery formed in accordance with Comparative Example 4. In particular, the LiI battery of Comparative Example 4 was formed, in part from, a carbon composite film including conducive carbon particles, a conversion-type positive electrode active material (LiI), and a polymeric binder, where the conductive carbon particles are coated with a layer of SiO₂ at the single-particle level. The charge curve 910 and the discharge curve 920 were acquired at a current density of 1 mA/cm². The charge and discharge capacities of the secondary energy storage device formed in accordance with Comparative Example 4 are lower than the charge and discharge capacities of the secondary energy storage device formed in accordance with Comparative Example 1-Control (see FIG. 4 for comparison).

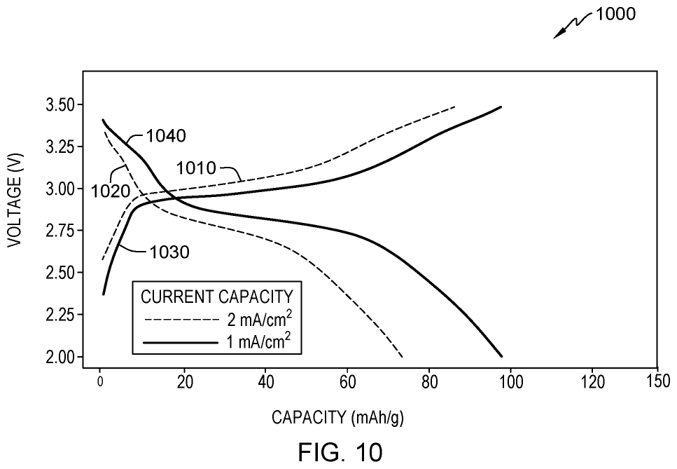

FIG. 10 is a plot, generally designated 1000, of the galvanostatic charge-discharge curves of the LiI battery formed in accordance with Comparative Example 5. In particular, the LiI battery of Comparative Example 5 was formed, in part from, a carbon composite film with an SiO₂ layer vapor-deposited onto the top surface of the carbon composite film, and a conversion-type positive electrode active material (Lil) deposited on top of the SiO₂ layer, where the carbon composite film includes conductive carbon particles and a polymeric binder. The charge curve 1010 and the discharge curve 1020 were acquired at a current density of 2 mA/cm², while the charge curve 1030 and the discharge curve 1040 were acquired at a current density of 1 mA/cm². The charge and discharge capacities of the secondary energy storage device formed in accordance with Comparative Example 5 are lower than the charge and discharge capacities of the secondary energy storage device formed in accordance with Comparative Example 1-Control (see FIG. 4 for comparison).

As can be seen by a comparison of the galvanostatic charge-discharge data in FIGS. 4-8, the LiI batteries that have a layer of SiO₂ formed on the top surface of the carbon composite film (i.e., the LiI batteries of Example 1 and Example 2) have a higher specific capacity compared to the LiI battery without the layer of SiO₂ formed on the top surface of the carbon composite film (i.e., LiI battery of Comparative Example 1-Control), while the Lil batteries that have a layer of Al₂O₃ or MnO₂ formed on the top surface of the composite film (i.e., the Lil batteries of Comparative Example 2 and Comparative Example 3) have a lower specific capacity compared to the LiI battery without the layer of SiO₂ formed on the top surface of the carbon composite film (i.e., LiI battery of Comparative Example 1-Control). This ultimately demonstrates that the particular compound formed on the top surface of the carbon composite film, as well as the electronegativity difference between the elements that form the compound, play a critical role in the overall performance of the battery. For example, the LiI battery including the carbon composite film with the layer of SiO₂ (the electronegativity difference of Si (1.9) and O (3.44) is 1.54) significantly outperformed the LiI batteries including the carbon composite films with layers of Al₂O₃ (the electronegativity difference of Al (1.61) and oxygen (3.44) is 1.83) and MnO₂ (the electronegativity difference of Mn (1.55) and oxygen (3.44) is 1.89).

Furthermore, as can seen by a comparison of the galvanostatic charge-discharge data in FIGS. 4-6, the Lil batteries that have a layer of SiO₂ formed on the top surface of the carbon composite film (i.e., the LiI batteries of Example 1 and Example 2) have a higher specific capacity compared to the LiI battery without the layer of SiO₂ formed on the top surface of the carbon composite film (i.e., LiI battery of Comparative Example 1-Control). Moreover, as can be seen by a comparison of the galvanostatic charge-discharge data in FIGS. 4-6, 9, and 10, the LiI battery in which the carbon particles of the carbon composite film are coated with the layer of SiO₂ at the single-particle level (i.e., the LiI battery of Comparative Example 4) has a lower specific capacity compared to the LiI batteries that have a layer of SiO₂ formed on the top surface of the carbon composite film (i.e., the LiI batteries of Example 1 and Example 2), and a slightly lower specific capacity than the Lil battery without the layer of SiO₂ formed on the top surface of the carbon composite film (i.e., the LiI battery of Comparative Example 1-Control Cell). This ultimately demonstrates that the particular location of the porous inorganic layer also plays a critical role in the overall performance of the battery.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A conversion-type positive electrode, comprising:
a composite film and a porous inorganic layer formed on a top surface of the composite film, wherein the composite film includes an electrically conductive porous material and a conversion-type positive electrode active material, and wherein the porous inorganic layer does not undergo a reversible redox reaction during cycling of the conversion-type positive electrode.

2. The conversion-type positive electrode of claim 1, wherein the composite film further includes a polymeric binder.

3. The conversion-type positive electrode of claim 1, wherein the porous inorganic layer formed on the top surface of the composite film includes a compound containing at least one metal or metalloid, and at least one non-metal, wherein a difference in electronegativity between the at least one non-metal and the at least one metal or metalloid is less than or equal to 1.8.

4. The conversion-type positive electrode of claim 3, wherein the at least one metalloid is selected from the group consisting of silicon, germanium, arsenic, antimony, boron, selenium, tellurium, and combinations thereof.

5. The conversion-type positive electrode of claim 2, wherein the at least one non-metal is selected from the group consisting of oxygen, nitrogen, phosphorus, carbon, sulfur, selenium, a halogen, and combinations thereof.

6. The conversion-type positive electrode of claim 1, wherein the porous inorganic layer formed on the top surface of the composite film includes at least one compound selected from the group consisting of polysilanes, polycarbosilanes, a polysiloxanes, polysilazanes, and combination thereof.

7. The conversion-type positive electrode of claim 1, wherein the porous inorganic layer formed on the top surface of the composite film is formed from at least one compound selected from the group consisting of silicon dioxide (SiO₂), an organosilicate precursor solution of hydrogen silsesquioxane (HSQ) in methyl isobutyl ketone (MIBK), and combinations thereof.

8. The conversion-type positive electrode of claim 1, wherein the porous inorganic layer formed on the top surface of the composite film includes at least one metal oxide selected from the group consisting of vanadium oxides, niobium oxides, tantalum oxides, chromium oxides, molybdenum oxides, tungsten oxides, and combinations thereof.

9. The conversion-type positive electrode of claim 1, wherein a thickness of the porous inorganic layer formed on the top surface of the composite layer is less than or equal to 25 micrometers.

10. A secondary energy storage device, comprising:
a negative electrode;
a liquid electrolyte including at least one solvent and at least one salt; and
a conversion-type positive electrode, wherein the conversion-type positive electrode includes a composite film and a porous inorganic layer formed on the top surface of the composite film, and further wherein the composite film includes an electrically conductive porous material and a conversion-type positive electrode active material.

11. The secondary energy storage device of claim 10, further comprising:
a positive current collector in direct contact with the bottom surface of the composite film;
a negative current collector in direct contact with the negative electrode; and
a separator located between the positive electrode and the negative electrode.

12. The secondary energy storage device of claim 10, wherein the porous inorganic layer formed on the top surface of the composite film includes a compound containing at least one metal or metalloid, and at least one non-metal, wherein a difference in electronegativity between the at least one non-metal and the at least one metal or metalloid is less than or equal to 1.8.

13. The secondary energy storage device of claim 12, wherein the at least one metalloid is selected from the group consisting of silicon, germanium, arsenic, antimony, boron, selenium, tellurium, and combinations thereof.

14. The secondary energy storage device of claim 12, wherein the at least one non-metal is selected from the group consisting of oxygen, nitrogen, phosphorus, carbon, sulfur, selenium, a halogen, and combinations thereof.

15. The secondary energy storage device of claim 10, wherein the porous inorganic layer formed on the top surface of the composite film includes at least one compound selected from the group consisting of polysilanes, polycarbosilanes, a polysiloxanes, polysilazanes, and combination thereof.

16. The secondary energy storage device of claim 10, wherein the porous inorganic layer formed on the top surface of the composite film is formed from at least one compound selected from the group consisting of silicon dioxide (SiO₂), an organosilicate precursor solution of hydrogen silsesquioxane (HSQ) in methyl isobutyl ketone (MIBK), and combinations thereof.

17. The secondary energy storage device of claim 10, wherein the porous inorganic layer formed on the top surface of the composite film includes at least one metal oxide selected from the group consisting of vanadium oxides, niobium oxides, tantalum oxides, chromium oxides, molybdenum oxides, tungsten oxides, and combinations thereof.

18. The secondary energy storage device of claim 10, wherein a thickness of the porous inorganic layer formed on the top surface of the composite layer is less than or equal to 25 micrometers.

19. A method of forming a conversion-type positive electrode, comprising:
preparing a slurry, wherein the slurry includes an electrically conductive porous material, a polymeric binder, and a solvent;
drying the slurry to form a composite film; and
depositing a porous inorganic material onto the top surface of the composite film to form a porous inorganic layer that coats the top surface of the composite film.

20. The method of claim 19, wherein the slurry further includes a conversion-type positive electrode active material.

21. The method of claim 19, further comprising:
adding a conversion-type positive electrode active material to the composite film prior to depositing the porous inorganic material onto the top surface of the composite film.

22. The method of claim 19, wherein the porous inorganic material is a compound containing at least one metal or metalloid, and at least one non-metal, wherein a difference in electronegativity between the at least one non-metal and the at least one metal or metalloid is less than or equal to 1.8.

23. The method of claim 19, wherein depositing the porous inorganic material onto the top surface of the composite film includes conformally depositing one or more thin film coatings of silicon dioxide (SiO₂) using chemical vapor deposition.

24. The method of claim 19, wherein depositing the porous inorganic material onto the top surface of the composite film includes:
preparing an organosilicate precursor solution of hydrogen silsesquioxane (HSQ) in methyl isobutyl ketone (MIBK);
depositing the solution onto the top surface of the composite film; and
thermally curing the solution to form a silicon dioxide (SiO₂) layer on the top surface of the composite film.

25. The method of claim 19, wherein a thickness of the porous inorganic layer formed on the top surface of the composite layer is less than or equal to 25 micrometers.
